(19) United States
(12) Patent Application Publication
(10) Pub. No.: US 2026/0342962 A1
(43) Pub. Date: Oct. 29, 2026

(54) ADAPTIVELY SELECTING PREDICTION MODES FOR DATA COMPRESSION

(71) Applicant: QUALCOMM Incorporated, San Diego, CA (US)

(72) Inventors: Sameera Balakrishna MARKOD, Bangalore (IN); Mohan Krishna MADINENI, Bengaluru (IN); Rahul KOPPISETTI, Bengaluru (IN); Venu PAKALAPATY, Bangalore (IN); Hyung Joon KIM, San Diego, CA (US); Huai-Nan PENG, Miaoli City (TW)

(21) Appl. No.: 19/193,815

(22) Filed: Apr. 29, 2025

(51) Int. Cl. H04N 19/103; H04N 19/14; H04N 19/174; H04N 19/176

(52) U.S. Cl. CPC H04N 19/103; H04N 19/14; H04N 19/174; H04N 19/176

(57) ABSTRACT

Systems and techniques are described herein for compressing data. For instance, a method for compressing data is provided. The method may include determining a plurality of compressed lengths for a subtile of input data using a plurality of prediction modes, wherein each compressed length of the plurality of compressed lengths is determined using a respective prediction mode of the plurality of prediction modes; selecting a prediction mode from among the plurality of prediction modes for the subtile based on the plurality of compressed lengths for the subtile; and compressing the subtile using the selected prediction mode.

### TECHNICAL FIELD

The present disclosure generally relates to data compression. For example, aspects of the present disclosure include systems and techniques for adaptively selecting prediction modes for data compression.

### BACKGROUND

Various types of data may be compressed for storage, transmission, etc. For example, pixel data of an image or images may be compressed to such that the image or images may be stored and/or transmitted using less storage space and/or transmission bandwidth. As another example, a neural-network data (e.g., weights of the neural network) may be compressed.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for compressing data. According to at least one example, a method is provided for compressing data. The method includes: determining a plurality of compressed lengths for a subtile of input data using a plurality of prediction modes, wherein each compressed length of the plurality of compressed lengths is determined using a respective prediction mode of the plurality of prediction modes; selecting a prediction mode from among the plurality of prediction modes for the subtile based on the plurality of compressed lengths for the subtile; and compressing the subtile using the selected prediction mode.

In another example, an apparatus for compressing data is provided that includes at least one memory and at least one processor (e.g., configured in circuitry) coupled to the at least one memory. The at least one processor configured to: determine a plurality of compressed lengths for a subtile of input data using a plurality of prediction modes, wherein each compressed length of the plurality of compressed lengths is determined using a respective prediction mode of the plurality of prediction modes; select a prediction mode from among the plurality of prediction modes for the subtile based on the plurality of compressed lengths for the subtile; and compress the subtile using the selected prediction mode.

In another example, a non-transitory computer-readable medium is provided that has stored thereon instructions that, when executed by one or more processors, cause the one or more processors to: determine a plurality of compressed lengths for a subtile of input data using a plurality of prediction modes, wherein each compressed length of the plurality of compressed lengths is determined using a respective prediction mode of the plurality of prediction modes; select a prediction mode from among the plurality of prediction modes for the subtile based on the plurality of compressed lengths for the subtile; and compress the subtile using the selected prediction mode.

In another example, an apparatus for compressing data is provided. The apparatus includes: means for determining a plurality of compressed lengths for a subtile of input data using a plurality of prediction modes, wherein each compressed length of the plurality of compressed lengths is determined using a respective prediction mode of the plurality of prediction modes; means for selecting a prediction mode from among the plurality of prediction modes for the subtile based on the plurality of compressed lengths for the subtile; and means for compressing the subtile using the selected prediction mode.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating example data arranged as a tile made up of subtiles, which are made up of blocks, which are made up of values;

FIG. 2 is a diagram illustrating an alternate division of a tile of values into subtiles and blocks;

FIG. 3 is a block diagram illustrating an example system for compressing raw data to generate output bitstream;

FIG. 4 is a diagram of an example process for determining a prediction mode based on statistics;

FIG. 5 is a block diagram illustrating an example system for compressing raw data to generate an output bitstream, according to various aspects of the present disclosure;

FIG. 6 is a diagram of an example process for determining a prediction mode, according to various aspects of the present disclosure;

FIG. 7 is a diagram illustrating an example data layout of bitstream of compressed data;

FIG. 8 is a diagram illustrating an example data layout of bitstream of compressed, according to various aspects of the present disclosure;

FIG. 9 is a flow diagram illustrating an example process for compressing data, in accordance with aspects of the present disclosure;

FIG. 10 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As mentioned above, various types of data may be compressed for storage, transmission, etc. For example, pixel data of an image or images may be compressed to such that the image or images may be stored and/or transmitted using less storage space and/or transmission bandwidth. As another example, a neural-network data (e.g., weights of the neural network) may be compressed.

For example, a tile of pixel or neural-network data can be compressed by adaptively selecting one of several prediction modes, such as a spatial-prediction mode (which may also be referred to as “left prediction”), a no-prediction mode, a min-max prediction mode, or a max(min=0) prediction mode. Spatial prediction may involve compressing the current component considering the neighboring components. No prediction may involve compressing the current component by dropping 0s from the most-significant bit (MSB) position. Min-max prediction may involve compressing the current component with regard to the minimum or maximum component of the current subtile. The max(min=0) prediction mode may be a special case of min-max prediction mode where min is considered as 0 for a subtile.

In conventional compression techniques, the selection of prediction mode is based on statistical calculations performed on the tile. Such selections may be based on various thresholds. Prediction-mode selection in conventional compression techniques may not always select the optimal prediction mode.

Systems, apparatuses, methods (also referred to as processes), and computer-readable media (collectively referred to herein as “systems and techniques”) are described herein for selecting prediction modes for data compression. For example, the systems and techniques described herein may evaluate a number of prediction modes for each block of a subtile of a tile of input data and select a prediction mode that results in the highest compression ratio (CR) for the blocks of the subtile.

For example, the systems and techniques may, for each block of a subtile of input data, determine a block length for each prediction mode of a number of prediction modes. The systems and techniques may aggregate the block lengths of all the blocks of each subtile for each prediction mode. Further, the systems and techniques may select the best prediction mode for each subtile based on block lengths for all the blocks of each subtile. For example, the systems and techniques may select the prediction mode that results in a highest CR for each subtile.

In min-max prediction, predictions for a given subtile are made relative to the minimum values and the maximum values of the subtile. For min-max prediction, each compressed data value includes 1 bit for the sign/mode. The bit indicates whether the prediction is based on the minimum value or the maximum value. In an example tile containing 256 data points, the compressed tile uses 256 bits to indicate the mode and an additional 8 bits for each minimum or maximum value.

For certain types of tiles, it may be more efficient to predict based solely on either the minimum value or the maximum value. In such cases, mode flags can be omitted from the compressed data, thereby improving the CR.

Various aspects of the application will be described with respect to the figures below.

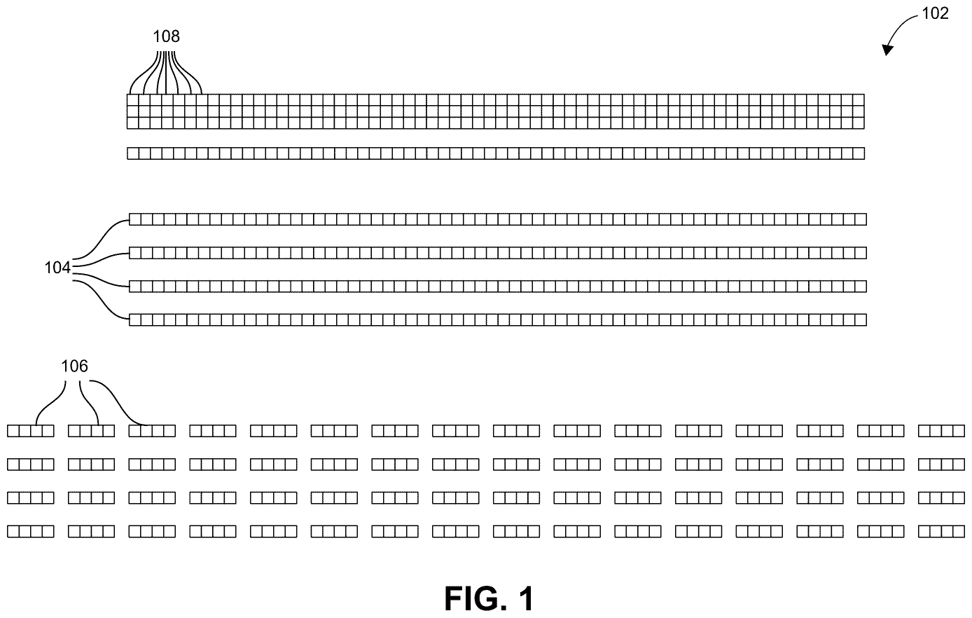

FIG. 1 is a diagram illustrating example data arranged as a tile made up of subtiles, which are made up of blocks, which are made up of values. For example, tile 102 includes 256 values 108. Each of values 108 may be, for example, a byte of data. Tile 102 may be divided into subtiles 104. A system may be capable of processing each of subtiles 104 in parallel. For example, the size of subtiles 104 may be determined based on an intended number of parallel processes. Further, each of subtiles 104 may be divided into blocks 106. Each of blocks 106 may be a compressible unit of data. For example, to compress data, it may be valuable to include enough data in a compressible unit to provide context for compressed values. Blocks 106 may be sized such that each of blocks 106 is a compressible unit of data.

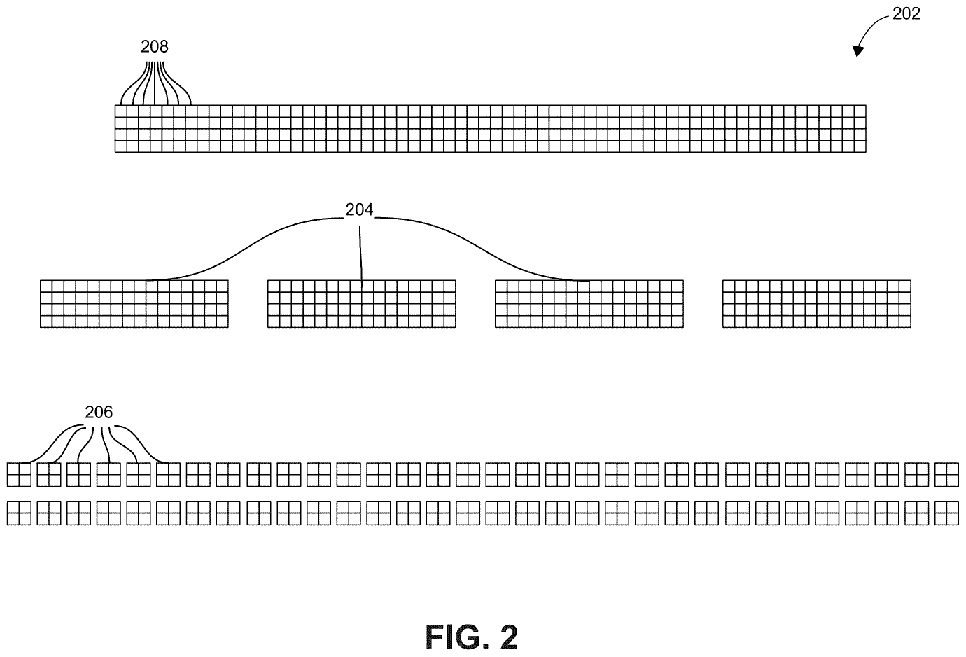

FIG. 2 is a diagram illustrating an alternate division of a tile of values into subtiles and blocks. For example, tile 202 of values 208 may be divided into subtiles 204. Subtiles 204 may be further divided into blocks 206.

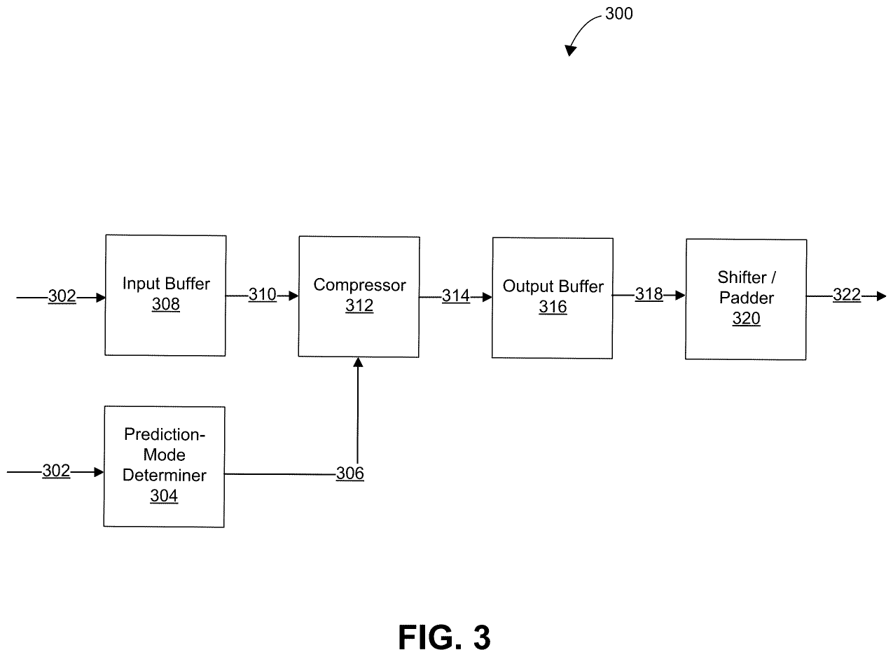

FIG. 3 is a block diagram illustrating an example system 300 for compressing raw data 302 to generate output bitstream 322. Raw data 302 may be, or may include, data to be compressed. Raw data 302 may be, or may include, data of any type (e.g., pixel data of an image or images, neural-network data, etc.).

Prediction-mode determiner 304 may determine prediction mode 306 to use to compress raw data 302 based on raw data 302. For example, prediction-mode determiner 304 may analyze raw data 302 based on statistical measures. Prediction-mode determiner 304 may determine prediction mode 306 based on the statistical measures and one or more thresholds.

Input buffer 308 may temporarily store raw data 302 (e.g., while prediction-mode determiner 304 analyzes raw data 302 to determine prediction mode 306). Input buffer 308 may output raw data 310 to compressor 312.

Compressor 312 may compress raw data 310 using prediction mode 306 (e.g., the prediction mode determined by prediction-mode determiner 304 based on raw data 302) to generate compressed data 314. In some aspects, prediction-mode determiner 304 may determine prediction mode 306 on a per-subtile basis. For example, using tile 102 as an example of raw data 302, prediction-mode determiner 304 may determine an instance of prediction mode 306 for each of subtiles 104. Additionally, compressor 312 may apply the determined prediction mode on a per-subtile basis. For example, compressor 312 may apply a prediction mode determined for each of subtiles 104.

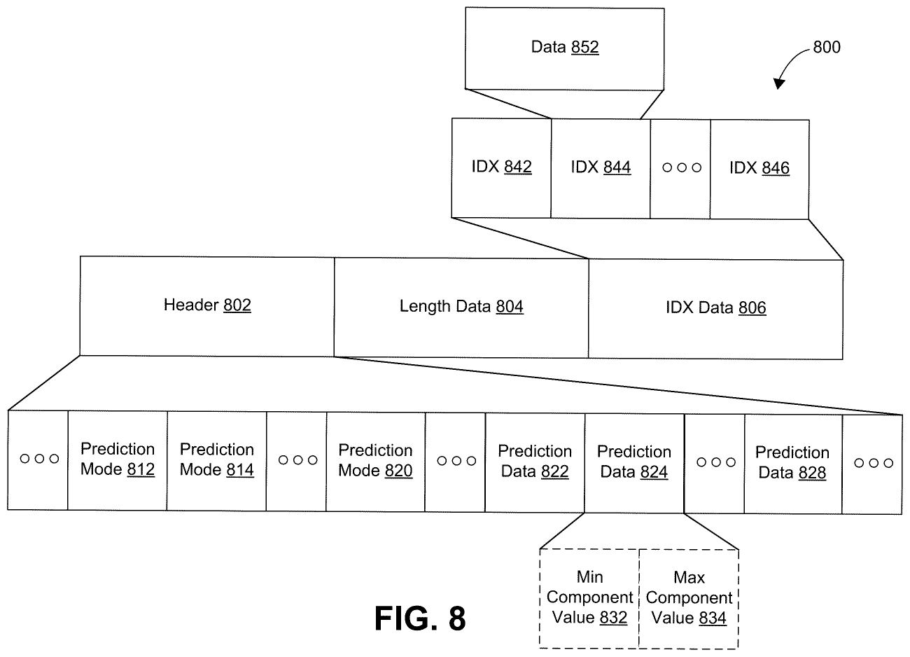

Compressor 312 may compress raw data 310 using any compression mode indicated by prediction mode 306. For example, compressor 312 may compress raw data 310 using a spatial-prediction mode, a no-prediction mode, a min-max prediction mode, or a max(min=0) prediction mode. Additional detail regarding the min-or-max prediction mode is provided with regard to FIG. 8.

Output buffer 316 may temporarily store compressed data 314 and output compressed data 318. Shifter/padder 320 may shift bits of compressed data 318 and/or pad values of compressed data 318. Shifter/padder 320 may output output bitstream 322.

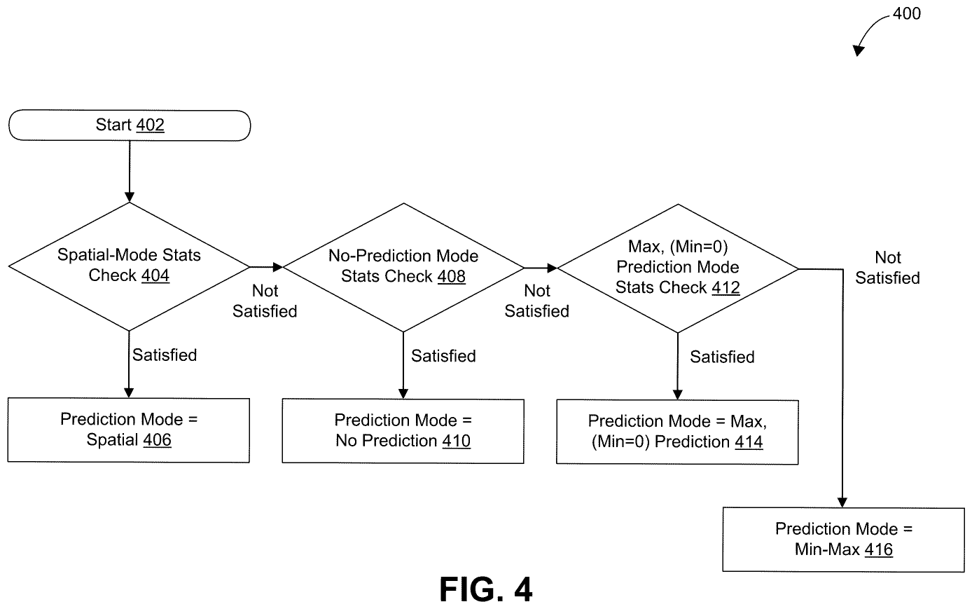

FIG. 4 is a diagram of an example process 400 for determining a prediction mode based on statistics. As an example, prediction-mode determiner 304 may implement process 400 to determine prediction mode 306.

For example, process 400 may start with a subtile of data at start block 402. At decision block 404, prediction-mode determiner 304 may determine whether conditions are satisfied for a spatial prediction mode. The conditions may be based on statistics regarding the subtile and one or more thresholds. If the conditions are satisfied, process 400 may proceed to block 406 in which the spatial prediction mode is determined as the prediction mode for the subtile. If the conditions are not satisfied, process 400 may proceed to decision block 408.

At decision block 408, prediction-mode determiner 304 may determine whether conditions are satisfied for a no-prediction mode. The conditions may be based on statistics regarding the subtile and one or more thresholds. If the conditions are satisfied, process 400 may proceed to block 410 in which the no-prediction mode is determined as the prediction mode for the subtile. If the conditions are not satisfied, process 400 may proceed to decision block 412.

At decision block 412, prediction-mode determiner 304 may determine whether conditions are satisfied for a max(min=0) prediction mode. The conditions may be based on statistics regarding the subtile and one or more thresholds. If the conditions are satisfied, process 400 may proceed to block 414 in which the max(min=0) prediction mode is determined as the prediction mode for the subtile. If the conditions are not satisfied, process 400 may proceed to decision block 416 in which a min-max prediction mode is determined as the prediction mode for the subtile.

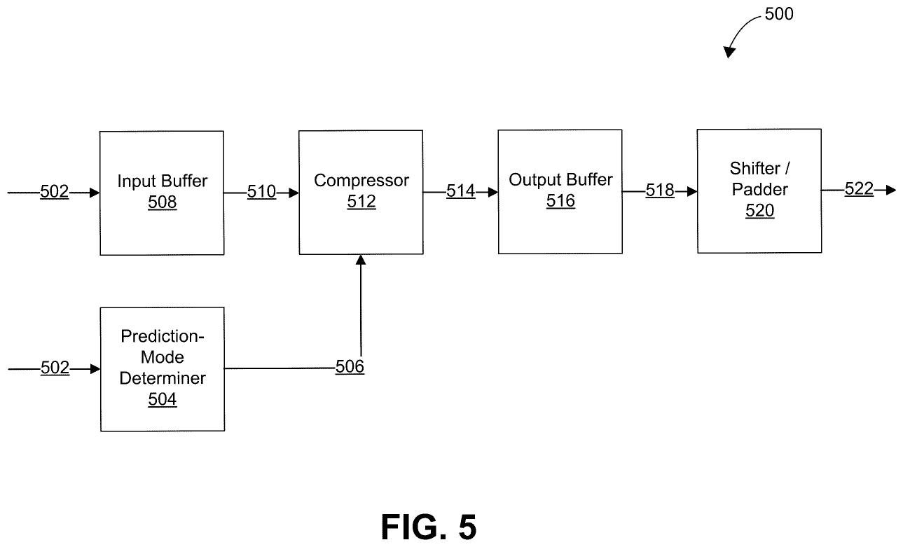

FIG. 5 is a block diagram illustrating an example system 500 for compressing raw data 502 to generate output bitstream 522, according to various aspects of the present disclosure. Raw data 502 may be, or may include, data to be compressed. Raw data 502 may be, or may include, data of any type (e.g., pixel data of an image or images, neural-network data, etc.).

Prediction-mode determiner 504 may determine prediction mode 506 to use to compress raw data 502 based on raw data 502. In contrast to prediction-mode determiner 304 of FIG. 3, prediction-mode determiner 504 may determine a prediction mode for each subtile by directly analyzing a compressed length of each block of the subtile according to each prediction mode.

Input buffer 508 may temporarily store raw data 502 (e.g., while prediction-mode determiner 504 analyzes raw data 502 to determine prediction mode 506). Input buffer 508 may output raw data 510 to compressor 512.

Compressor 512 may compress raw data 510 using prediction mode 506 (e.g., the prediction mode determined by prediction-mode determiner 504 based on raw data 502) to generate compressed data 514. In some aspects, prediction-mode determiner 504 may determine prediction mode 506 on a per-subtile basis. For example, using tile 102 as an example of raw data 502, prediction-mode determiner 504 may determine an instance of prediction mode 506 for each of subtiles 104. Additionally, compressor 512 may apply the determined prediction mode 506 on a per-subtile basis. For example, compressor 512 may apply a prediction mode determined for each of subtiles 104.

Compressor 512 may compress raw data 510 using any compression mode indicated by prediction mode 506. For example, compressor 512 may compress raw data 510 using a spatial-prediction mode, a no-prediction mode, a min-max prediction mode, a min-or-max prediction mode, or a max(min=0) prediction mode. Additional detail regarding the min-or-max prediction mode is provided with regard to FIG. 8.

Output buffer 516 may temporarily store compressed data 514 and output compressed data 518. Shifter/padder 520 may shift bits of compressed data 518 and/or pad values of compressed data 518. Shifter/padder 520 may output output bitstream 522.

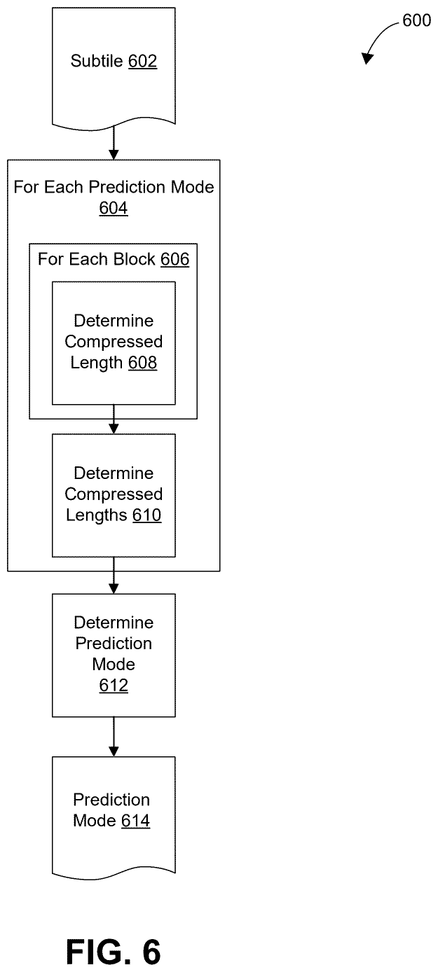

FIG. 6 is a diagram of an example process 600 for determining a prediction mode, according to various aspects of the present disclosure. As an example, prediction-mode determiner 504 may implement process 600 to determine prediction mode 506.

Subtile 602 may be a subtile of a tile of input data. Subtile 602 may represent a division of the tile according to any suitable division scheme.

For loop 604 may be a block in process 600 indicating that the operations within for loop 604 are performed once for each prediction mode available. For example, process 600 may perform the operations within for loop 604 for once for each of a spatial-prediction mode, a no-prediction mode, a max(min=0) mode, a min-max prediction mode, and/or a min-or-max prediction mode. Additional detail regarding the min-or-max prediction mode is provided with regard to FIG. 8. Similarly, for loop 606 may be a block in process 600 indicating that operations within for loop 606 are performed once for each block of subtile 602.

At determine compressed length 608, a compressed length of a block may be determined. For example, a block may have an initial length (e.g., be made up of a number of bits). The block may be compressed using a prediction mode. After compression, the block may have a compressed length (e.g., be represented by a number of bits). The compressed length may be shorter than the initial length.

At determine compressed length 608, a compressed length for each block of subtile 602 may be determined for each of the prediction modes. For example, for a first block of subtile 602, prediction-mode determiner 504 may determine a compressed length of the first block if the first block were compressed using each of a spatial-prediction mode, a no-prediction mode, a max(min=0) mode, a min-max prediction mode, and/or a min-or-max prediction mode. Similarly, prediction-mode determiner 504 may determine a compressed length of a second block if the first block were compressed using each of a spatial-prediction mode, a no-prediction mode, a max(min=0) mode, a min-max prediction mode, and/or a min-or-max prediction mode.

For the spatial-prediction mode, prediction-mode determiner 504 may determine the compressed length (e.g., number of bits of subtile 602 as compressed) as the number of bits for the maximum of (current component−neighboring component) in 4 components in a block+block fixed length coding (BFLC) data length. When 4 values inside a block are compressed, all the 4 compressed values in a given block are represented in same/fixed size/length. The term “current component” may refer to a component that is being compressed whereas the term “neighboring component” may refer to the component that is placed a side (e.g., left side) of the current component in the tile arrangement. The term “BFLC data length” may refer to the information about number of bits required to represent the size/length of compressed block.

For the no-prediction mode, prediction-mode determiner 504 may determine the compressed length as the number of bits for the maximum component in each block+BFLC data length.

For the min-max prediction mode, prediction-mode determiner 504 may determine the compressed length as the number of bits for the maximum of (the minimum of {component−MIN, MAX−component} in 4 components in a block)+BFLC data length. The term “MIN” may refer to the minimum component of a subtile. The term “MAX” may refer to the maximum component of a subtile. The term “minimum of {. . . }” may refer to a function to determine minimum value.

For a max(min=0) prediction mode, prediction-mode determiner 504 may determine the compressed length as the number of bits for the maximum of (the minimum of {component, MAX−component} in 4 components in a block)+BFLC data length.

For a min-based prediction of a min-or-max prediction mode, prediction-mode determiner 504 may determine the compressed length as the number of bits for (the maximum component of the block−MIN)+BFLC data length.

For a max-based prediction of a min-or-max prediction mode, prediction-mode determiner 504 may determine the compressed length as the number of bits (MAX−minimum comp of the block)+BFLC data length.

At determine compressed lengths 610, a length of a subtile may be determined for each of the prediction modes. For example, a compressed length of subtile 602 using each of the prediction modes may be determined. The compressed length of the subtile may include the lengths of each of the compressed blocks of the subtile. Additionally, the compressed length of a subtile may include header data (e.g., header data related to the prediction mode).

At determine prediction mode 612, prediction-mode determiner 504 may determine a prediction mode 614 to use to compress subtile 602. For example, determine prediction mode 612 may select the prediction mode that will result in the shortest compressed length of subtile 602.

Process 600 may operate independently of external inputs such as thresholds. Conventional statistical calculations (e.g., as described with regard to process 400 of FIG. 4) use external inputs for thresholds to fine tune calculations. Process 600 may be performed in parallel for all prediction modes, including a spatial-prediction mode, a no-prediction mode, a min-max prediction mode, a max(min=0) prediction mode, and a min-or-max prediction mode.

Process 600 may generate a bitstream with the optimal length because process 600 may select the optimal prediction mode for each subtile. As such, process 600 may achieve the highest possible compression ratio relative to the available prediction modes.

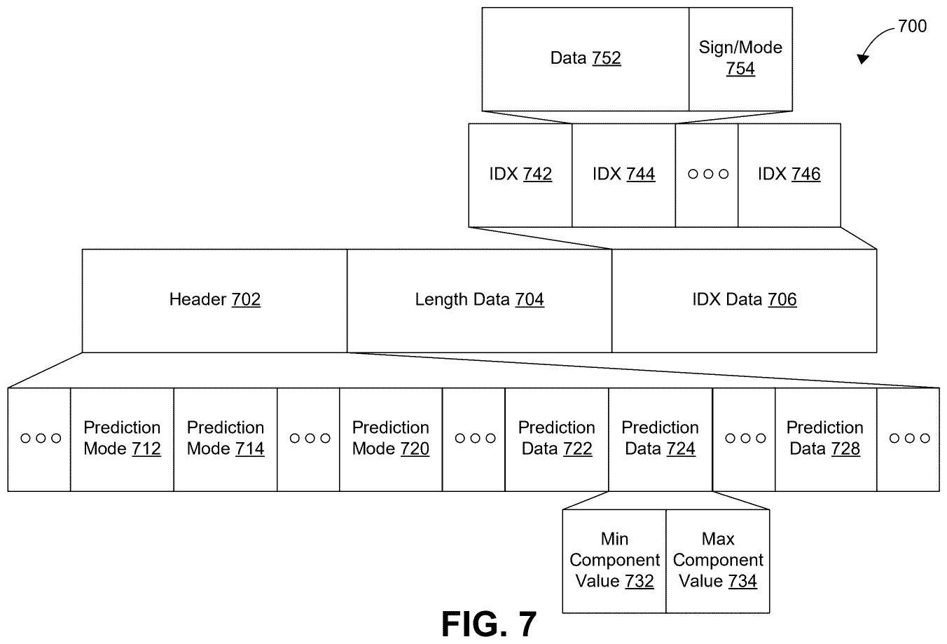

FIG. 7 is a diagram illustrating an example data layout of bitstream 700 of compressed data. A compressed bitstream 700 may include three parts, for example, header 702, length data 704, and IDX data 706. Bitstream 700 may represent data as compressed according to a min-max prediction mode.

Header 702 may include prediction modes and prediction data. The prediction modes may specify the type of prediction used for each subtile (e.g., spatial prediction, no-prediction, min-max prediction, max(min=0) prediction, or min-or-max prediction). The prediction data may include the data to perform the prediction. For instance, for a spatial prediction, the prediction data may include a first component.

For each subtile represented by bitstream 700, header 702 may include a number of bits indicating a prediction mode and a number of bits of prediction data. For example, for a first example subtile, header 702 may include prediction mode 712 and prediction data 722. For a second example subtile, header 702 may include prediction mode 714 and prediction data 724 and for a third example subtile (e.g., a last subtile of a tile), header 702 may include prediction mode 720 and prediction data 728.

Each subtile (or, in some cases, each tile) may be compressed using a different prediction mode (e.g., spatial prediction, no prediction, min/max prediction, or min-or-max prediction). The selection of prediction mode may be based on statistical calculations performed on the tile (e.g., as described with regard to FIG. 3 and FIG. 4). Alternatively, according to various aspects of the present disclosure, selection of prediction mode may be based on calculations for each block and each prediction method (e.g., as described with regard to FIG. 5 and FIG. 6).

Length data 704 may indicate the length of the IDX data for each block of each subtile. The length of the IDX data for blocks may depend on the maximum size of the IDX within the block.

IDX data 706 may be, or may include, compressed indices for each component. For example, IDX data 706 may include a number of values (e.g., binary values), one for each block (e.g., IDX 742, IDX 744, and IDX 746).

For prediction according to the min-max prediction mode, prediction data (e.g., prediction data 724) may include the minimum and maximum values in the tile (e.g., min component value 732 and max component value 734). As such the prediction data for each subtile may include twice the bit width of the values stored in the uncompressed data (e.g., 2*Pixel/Nndata BITWIDTH bits). For the min-max prediction mode, both the minimum and the maximum values are used because components within a subtile can use either minimum or maximum prediction.

Additionally, according to the min-max prediction mode, each component's IDX data includes 1 bit for the sign/mode. The sign/mode bit may indicate whether maximum or minimum prediction is used for compressing the component. For example, for a given block, IDX data 706 may include data 752 (e.g., compressed data representing values of the block) and sign/mode 754 (e.g., an indication of whether data 752 was compressed using minimum or maximum prediction). As the number of components in a tile increases, a significant number of bits will be needed for the sign/mode bit in the bitstream. For example, for a tile size of 256 bytes (e.g., divided in 4 subtiles with each subtile divided into 64 components) and predicted using the min-max prediction mode, the compressed tile requires 256 bits to indicate the mode. Additionally, it needs 8 bits each for the Min and Max value indicators.

In some cases, the min-or-max prediction mode may compress data into a bitstream with a higher compression ratio (CR) than the min-max prediction mode. Accordingly, having the min-or-max prediction mode as an option may allow a compression system (e.g., system 300 of FIG. 3 and/or system 500 of FIG. 5) to achieve a higher CR when compressing data.

FIG. 8 is a diagram illustrating an example data layout of bitstream 800 of compressed data, according to various aspects of the present disclosure. Bitstream 800 may represent data as compressed according to a min-or-max prediction mode. The bitstream 800 may include header 802, length data 804, and IDX data 806, similar to the bitstream 700 of FIG. 7.

Header 802 may include prediction modes and prediction data. The prediction modes may specify the type of prediction used for each subtile (e.g., spatial prediction, no-prediction, min-max prediction, max(min=0) prediction, or min-or-max prediction). The prediction data may include the data to perform the prediction. For instance, for a spatial prediction, the prediction data may include a first component.

For each subtile represented by bitstream 800, header 802 may include a number of bits indicating a prediction mode and a number of bits of prediction data. For example, for a first example subtile, header 802 may include prediction mode 812 and prediction data 822. For a second example subtile, header 802 may include prediction mode 814 and prediction data 824 and for a third example subtile (e.g., a last subtile of a tile), header 802 may include prediction mode 820 and prediction data 828.

Length data 804 may indicate the length of the IDX data for each block of each subtile. The length of the IDX data for blocks may depend on the maximum size of the IDX within the block. IDX data 806 may be, or may include, compressed indices for each component. For example, IDX data 806 may include a number of values (e.g., binary values), one for each block (e.g., IDX 842, IDX 844, and IDX 846).

In some subtiles the values of most components may be closer to either the maximum or minimum value. In such cases, it may be more efficient to use only minimum prediction or max prediction for the subtile, instead of min-max prediction (which may select minimum prediction or maximum prediction on a per-block basis). By fixing the prediction to either minimum prediction or maximum prediction for each subtile, the mode flags (e.g., sign/mode 754) can be omitted from the bitstream, improving the compression efficiency.

The min-or-max prediction mode may provide a benefit based on a product of the number of components and the number of blocks. For example, the min-or-max prediction mode may decrease the size of a bitstream representing a tile by NUM_COMP*NUM_BLK) bits per subtile.

For example, in the min-max prediction mode, prediction data (e.g., prediction data 824) may include minimum and maximum components (e.g., min component value 832 and max component value 834). Additionally, a block IDX data (e.g., IDX 844) may include IDX data (e.g., data 852) and a sign/mode bit (e.g., sign/mode 754). As such, a product of the number of components and the number of blocks bits (e.g., NUM_COMP*NUM_BLK bits) may be used to compress a tile.

In contrast, in the min-or-max prediction mode, prediction data (e.g., prediction data 824) may include either a minimum component or a maximum component (e.g., one or the other of min component value 832 or max component value 834). Additionally, for a block of IDX data (e.g., IDX 844) may include data 852 without a sign/mode bit. As such, data compressed according to the min-or-max prediction mode may conserve as much as a product of the number of components and the number of blocks bits plus one bit width for each subtile (e.g., (NUM_COMP*NUM_BLK+1*BITWIDTH)*NUM_SUBTILE).

The selection between minimum prediction, maximum prediction, or min-max prediction (e.g., as made by prediction-mode determiner 504) may be based on the actual bitstream length calculation for the tile. This allows for selecting the most efficient prediction method to optimize compression.

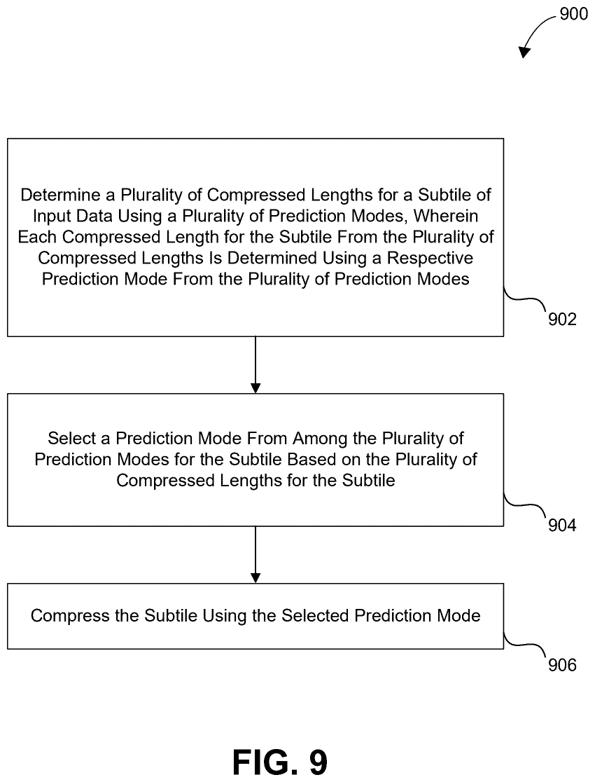

FIG. 9 is a flow diagram illustrating an example process 900 for compressing data, in accordance with aspects of the present disclosure. One or more operations of process 900 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 900. The one or more operations of process 900 may be implemented as software components that are executed and run on one or more processors.

At block 902, a computing device (or one or more components thereof) may determine a plurality of compressed lengths for a subtile of input data using a plurality of prediction modes, wherein each compressed length of the plurality of compressed lengths is determined using a respective prediction mode of the plurality of prediction modes. For example, prediction-mode determiner 504 may determine a length of a subtile according to each of a plurality of prediction modes. For instance, as described with regard to loop 604 of FIG. 6, for each of a plurality of prediction modes (e.g., a no-prediction mode, a min-max prediction mode, a max(min=0) prediction mode and a min-or-max prediction mode), prediction-mode determiner 504 may determine a respective length of a subtile (e.g., subtile 602).

In some aspects, to determine the plurality of compressed lengths for the subtile, the computing device (or one or more components thereof) may determine a respective compressed length of each block of the subtile using each prediction mode of the plurality of prediction modes. For example, prediction-mode determiner 504 may determine a compressed length for each block of the subtile using each of the prediction modes (e.g., as described with regard to loop 604, loop 606 and compressed length 608 of FIG. 6).

In some aspects, the computing device (or one or more components thereof) may determine a plurality of compressed subtile lengths, wherein each compressed subtile length of the plurality of compressed subtile lengths relates to a subtile of a tile of the input data; select a plurality of prediction modes from among the plurality of prediction modes, wherein each prediction mode of the plurality of prediction modes relates to a subtile of the tile; and compress the tile using the plurality of selected prediction modes. For example, prediction-mode determiner 504 may prediction-mode determiner 504 may determine a compressed subtile length for each subtile of a tile. Further, prediction-mode determiner 504 may select a prediction mode for each subtile of the tile and compress each tile using the selected prediction mode.

In some aspects, the plurality of prediction modes includes: a spatial-prediction mode, a no-prediction mode, and a min-max prediction mode. In some aspects, the plurality of prediction modes includes: no-prediction mode, a min-max prediction mode, a max(min=0) prediction mode and a min-or-max prediction mode.

In some aspects, the plurality of prediction modes includes a min-or-max prediction, wherein compressing the subtile using the min-or-max prediction includes: determining a minimum value of the subtile; determining a maximum value of the subtile; determining to compress the subtile based on either the minimum value or the maximum value; and compressing each value of the subtile relative to either the minimum value or the maximum value. For example, to compress a subtile using the min-or-max prediction mode, compressor 512 may determine a minimum value of the subtile; determine a maximum value of the subtile; determine to compress the subtile based on either the minimum value or the maximum value; and compress each value of the subtile relative to either the minimum value or the maximum value (e.g., as described with regard to FIG. 8).

In some aspects, the computing device (or one or more components thereof) may may include either the minimum value or the maximum value in a header of a bitstream including the compressed subtile (e.g., as described with regard to FIG. 8).

At block 904, the computing device (or one or more components thereof) may select a prediction mode from among the plurality of prediction modes for the subtile based on the plurality of compressed lengths for the subtile. For example, prediction-mode determiner 504 may select prediction mode 506 from among the plurality of prediction modes based on the plurality of lengths determine at block 902. For instance, as described with regard to prediction mode 612 of FIG. 6, prediction-mode determiner 504 may determine a prediction mode 506.

At block 906, the computing device (or one or more components thereof) may compress the subtile using the selected prediction mode. For example, compressor 512 may compress raw data 510 according to prediction mode 506 to generate compressed data 514.

In some aspects, the computing device (or one or more components thereof) may store the compressed subtile (e.g., for later usage). Additionally or alternatively, in some aspects, the computing device (or one or more components thereof) may transmit the compressed value (e.g., for use by another device).

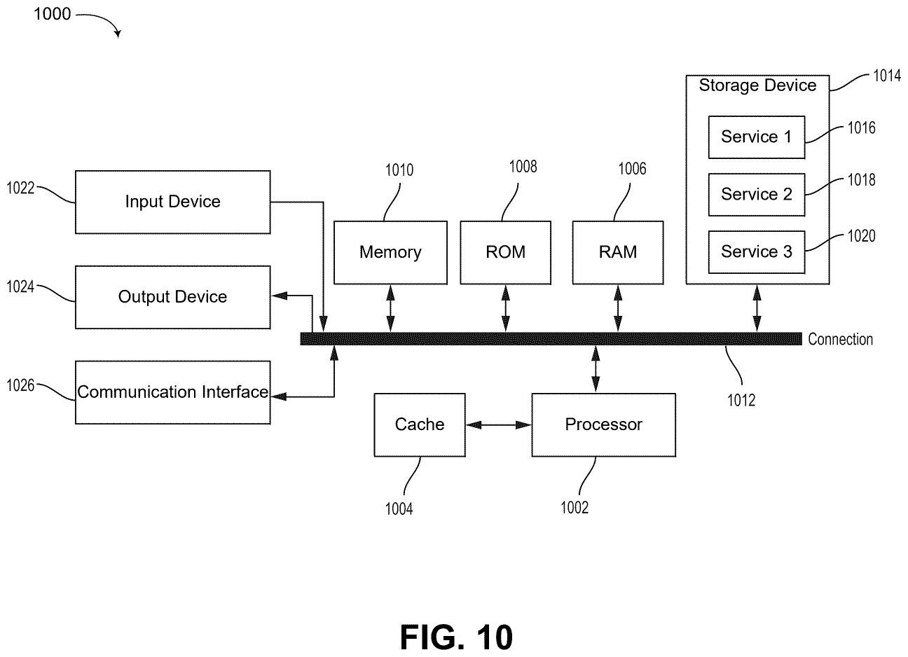

In some examples, as noted previously, the methods described herein (e.g., process 400 of FIG. 4, process 600 of FIG. 6, process 900 of FIG. 9, and/or other methods described herein) can be performed, in whole or in part, by a computing device or apparatus. In one example, one or more of the methods can be performed by system 300 of FIG. 3, system 500 of FIG. 5, or by another system or device. In another example, one or more of the methods (e.g., process 400, process 600, process 900, and/or other methods described herein) can be performed, in whole or in part, by the computing-device architecture 1000 shown in FIG. 10. For instance, a computing device with the computing-device architecture 1000 shown in FIG. 10 can include, or be included in, the components of the system 300 and/or system 500 and can implement the operations of process 900, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 400, process 600, process 900, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 400, process 600, process 900, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 10 illustrates an example computing-device architecture 1000 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1000 may include, implement, or be included in any or all of system 300 of FIG. 3, system 500 of FIG. 5, and/or other devices, modules, or systems described herein. Additionally or alternatively, computing-device architecture 1000 may be configured to perform process 400 of FIG. 4, process 600 of FIG. 6, process 900 of FIG. 9, and/or other process described herein.

The components of computing-device architecture 1000 are shown in electrical communication with each other using connection 1012, such as a bus. The example computing-device architecture 1000 includes a processing unit (CPU or processor) 1002 and computing device connection 1012 that couples various computing device components including computing device memory 1010, such as read only memory (ROM) 1008 and random-access memory (RAM) 1006, to processor 1002.

Computing-device architecture 1000 can include a cache of high-speed memory connected directly with, in close proximity to, or integrated as part of processor 1002. Computing-device architecture 1000 can copy data from memory 1010 and/or the storage device 1014 to cache 1004 for quick access by processor 1002. In this way, the cache can provide a performance boost that avoids processor 1002 delays while waiting for data. These and other modules can control or be configured to control processor 1002 to perform various actions. Other computing device memory 1010 may be available for use as well. Memory 1010 can include multiple different types of memory with different performance characteristics. Processor 1002 can include any general-purpose processor and a hardware or software service, such as service 1 1016, service 2 1018, and service 3 1020 stored in storage device 1014, configured to control processor 1002 as well as a special-purpose processor where software instructions are incorporated into the processor design. Processor 1002 may be a self-contained system, containing multiple cores or processors, a bus, memory controller, cache, etc. A multi-core processor may be symmetric or asymmetric.

To enable user interaction with the computing-device architecture 1000, input device 1022 can represent any number of input mechanisms, such as a microphone for speech, a touch-sensitive screen for gesture or graphical input, keyboard, mouse, motion input, speech and so forth. Output device 1024 can also be one or more of a number of output mechanisms known to those of skill in the art, such as a display, projector, television, speaker device, etc. In some instances, multimodal computing devices can enable a user to provide multiple types of input to communicate with computing-device architecture 1000. Communication interface 1026 can generally govern and manage the user input and computing device output. There is no restriction on operating on any particular hardware arrangement and therefore the basic features here may easily be substituted for improved hardware or firmware arrangements as they are developed.

Storage device 1014 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1006, read only memory (ROM) 1008, and hybrids thereof. Storage device 1014 can include services 1016, 1018, and 1020 for controlling processor 1002. Other hardware or software modules are contemplated. Storage device 1014 can be connected to the computing device connection 1012. In one aspect, a hardware module that performs a particular function can include the software component stored in a computer-readable medium in connection with the necessary hardware components, such as processor 1002, connection 1012, output device 1024, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for compressing data, the apparatus comprising: at least one memory; and at least one processor coupled to the at least one memory and configured to: determine a plurality of compressed lengths for a subtile of input data using a plurality of prediction modes, wherein each compressed length of the plurality of compressed lengths is determined using a respective prediction mode of the plurality of prediction modes; select a prediction mode from among the plurality of prediction modes for the subtile based on the plurality of compressed lengths for the subtile; and compress the subtile using the selected prediction mode.

Aspect 2. The apparatus of Aspect 1, wherein, to determine the plurality of compressed lengths for the subtile, the at least one processor is configured to determine a respective compressed length of each block of the subtile using each prediction mode of the plurality of prediction modes.

Aspect 3. The apparatus of any of Aspects 1 or 2, wherein the at least one processor is configured to: determine a plurality of compressed subtile lengths, wherein each compressed subtile length of the plurality of compressed subtile lengths relates to a subtile of a tile of the input data; select a plurality of prediction modes from among the plurality of prediction modes, wherein each prediction mode of the plurality of prediction modes relates to a subtile of the tile; and compress the tile using the plurality of selected prediction modes.

Aspect 4. The apparatus of any of Aspects 1 to 3, wherein the plurality of prediction modes comprises: a spatial-prediction mode, a no-prediction mode, and a min-max prediction mode.

Aspect 5. The apparatus of any of Aspects 1 to 4, wherein the plurality of prediction modes comprise: a min-or-max prediction, wherein compressing the subtile using the min-or-max prediction comprises: determining a minimum value of the subtile; determining a maximum value of the subtile; determining to compress the subtile based on either the minimum value or the maximum value; and compressing each value of the subtile relative to either the minimum value or the maximum value.

Aspect 6. The apparatus of Aspect 5, wherein the at least one processor is configured to include either the minimum value or the maximum value in a header of a bitstream including the compressed subtile.

Aspect 7. The apparatus of any of Aspects 1 to 6, wherein the at least one processor is configured to store the compressed subtile.

Aspect 8. The apparatus of any of Aspects 1 to 7, wherein the at least one processor is configured to transmit the compressed subtile.

Aspect 9. A method for compressing data, the method comprising: determining a plurality of compressed lengths for a subtile of input data using a plurality of prediction modes, wherein each compressed length of the plurality of compressed lengths is determined using a respective prediction mode of the plurality of prediction modes; selecting a prediction mode from among the plurality of prediction modes for the subtile based on the plurality of compressed lengths for the subtile; and compressing the subtile using the selected prediction mode.

Aspect 10. The method of Aspect 9, wherein determining the plurality of compressed lengths for the subtile comprises determining a respective compressed length of each block of the subtile using each prediction mode of the plurality of prediction modes.

Aspect 11. The method of any of Aspects 9 or 10, further comprising: determining a plurality of compressed subtile lengths, wherein each compressed subtile length of the plurality of compressed subtile lengths relates to a subtile of a tile of the input data; selecting a plurality of prediction modes from among the plurality of prediction modes, wherein each prediction mode of the plurality of prediction modes relates to a subtile of the tile; and compressing the tile using the plurality of selected prediction modes.

Aspect 12. The method of any of Aspects 9 to 11, wherein the plurality of prediction modes comprises: a spatial-prediction mode, a no-prediction mode, and a min-max prediction mode.

Aspect 13. The method of any of Aspects 9 to 12, wherein the plurality of prediction modes comprise: a min-or-max prediction, wherein compressing the subtile using the min-or-max prediction comprises: determining a minimum value of the subtile; determining a maximum value of the subtile; determining to compress the subtile based on either the minimum value or the maximum value; and compressing each value of the subtile relative to either the minimum value or the maximum value.

Aspect 14. The method of Aspect 13, further comprising including either the minimum value or the maximum value in a header of a bitstream including the compressed subtile.

Aspect 15. The method of any of Aspects 9 to 14, further comprising storing the compressed subtile.

Aspect 16. The method of any of Aspects 9 to 15, further comprising transmitting the compressed subtile.

Aspect 17. A non-transitory computer-readable storage medium having stored thereon instructions that, when executed by at least one processor, cause the at least one processor to perform operations according to any of Aspects 9 to 16.

Aspect 18. An apparatus one or more means for performing operations according to any of Aspects 9 to 16.

What is claimed is:

1. An apparatus for compressing data, the apparatus comprising:
at least one memory; and
at least one processor coupled to the at least one memory and configured to:
determine a plurality of compressed lengths for a subtile of input data using a plurality of prediction modes, wherein each compressed length of the plurality of compressed lengths is determined using a respective prediction mode of the plurality of prediction modes;
select a prediction mode from among the plurality of prediction modes for the subtile based on the plurality of compressed lengths for the subtile; and
compress the subtile using the selected prediction mode.

2. The apparatus of claim 1, wherein, to determine the plurality of compressed lengths for the subtile, the at least one processor is configured to determine a respective compressed length of each block of the subtile using each prediction mode of the plurality of prediction modes.

3. The apparatus of claim 1, wherein the at least one processor is configured to:
determine a plurality of compressed subtile lengths, wherein each compressed subtile length of the plurality of compressed subtile lengths relates to a subtile of a tile of the input data;
select a plurality of prediction modes from among the plurality of prediction modes, wherein each prediction mode of the plurality of prediction modes relates to a subtile of the tile; and
compress the tile using the plurality of selected prediction modes.

4. The apparatus of claim 1, wherein the plurality of prediction modes comprises:
a spatial-prediction mode,
a no-prediction mode, and
a min-max prediction mode.

5. The apparatus of claim 1, wherein the plurality of prediction modes comprise:
a min-or-max prediction, wherein compressing the subtile using the min-or-max prediction comprises:
determining a minimum value of the subtile;
determining a maximum value of the subtile;
determining to compress the subtile based on either the minimum value or the maximum value; and
compressing each value of the subtile relative to either the minimum value or the maximum value.

6. The apparatus of claim 5, wherein the at least one processor is configured to include either the minimum value or the maximum value in a header of a bitstream including the compressed subtile.

7. The apparatus of claim 1, wherein the at least one processor is configured to store the compressed subtile.

8. The apparatus of claim 1, wherein the at least one processor is configured to transmit the compressed subtile.

9. A method for compressing data, the method comprising:
determining a plurality of compressed lengths for a subtile of input data using a plurality of prediction modes, wherein each compressed length of the plurality of compressed lengths is determined using a respective prediction mode of the plurality of prediction modes;
selecting a prediction mode from among the plurality of prediction modes for the subtile based on the plurality of compressed lengths for the subtile; and
compressing the subtile using the selected prediction mode.

10. The method of claim 9, wherein determining the plurality of compressed lengths for the subtile comprises determining a respective compressed length of each block of the subtile using each prediction mode of the plurality of prediction modes.

11. The method of claim 9, further comprising:
determining a plurality of compressed subtile lengths, wherein each compressed subtile length of the plurality of compressed subtile lengths relates to a subtile of a tile of the input data;
selecting a plurality of prediction modes from among the plurality of prediction modes, wherein each prediction mode of the plurality of prediction modes relates to a subtile of the tile; and
compressing the tile using the plurality of selected prediction modes.

12. The method of claim 9, wherein the plurality of prediction modes comprises:
a spatial-prediction mode,
a no-prediction mode, and
a min-max prediction mode.

13. The method of claim 9, wherein the plurality of prediction modes comprise:
a min-or-max prediction, wherein compressing the subtile using the min-or-max prediction comprises:
determining a minimum value of the subtile;
determining a maximum value of the subtile;
determining to compress the subtile based on either the minimum value or the maximum value; and
compressing each value of the subtile relative to either the minimum value or the maximum value.

14. The method of claim 13, further comprising including either the minimum value or the maximum value in a header of a bitstream including the compressed subtile.

15. The method of claim 9, further comprising storing the compressed subtile.

16. The method of claim 9, further comprising transmitting the compressed subtile.

17. A non-transitory computer-readable storage medium having stored thereon instructions that, when executed by at least one processor, cause the at least one processor to:
determine a plurality of compressed lengths for a subtile of input data using a plurality of prediction modes, wherein each compressed length of the plurality of compressed lengths is determined using a respective prediction mode of the plurality of prediction modes;
select a prediction mode from among the plurality of prediction modes for the subtile based on the plurality of compressed lengths for the subtile; and
compress the subtile using the selected prediction mode.

18. The non-transitory computer-readable storage medium of claim 17, wherein, to determine the plurality of compressed lengths for the subtile, the instructions, when executed by the at least one processor, cause the at least one processor to determine a respective compressed length of each block of the subtile using each prediction mode of the plurality of prediction modes.

19. The non-transitory computer-readable storage medium of claim 17, the instructions, when executed by the at least one processor, cause the at least one processor to:
determine a plurality of compressed subtile lengths, wherein each compressed subtile length of the plurality of compressed subtile lengths relates to a subtile of a tile of the input data;
select a plurality of prediction modes from among the plurality of prediction modes, wherein each prediction mode of the plurality of prediction modes relates to a subtile of the tile; and
compress the tile using the plurality of selected prediction modes.

20. The non-transitory computer-readable storage medium of claim 17, wherein the plurality of prediction modes comprise:
a min-or-max prediction, wherein compressing the subtile using the min-or-max prediction comprises:
determining a minimum value of the subtile;
determining a maximum value of the subtile;
determining to compress the subtile based on either the minimum value or the maximum value; and
compressing each value of the subtile relative to either the minimum value or the maximum value.
